(19) United States
(12) Patent Application Publication
(10) Pub. No.: US 2018/0207744 A1
(43) Pub. Date: Jul. 26, 2018

(54) SENSOR FOR WELD WIRE SUPPLY DRUM

(71) Applicant: Genesis Systems Group, LLC, Davenport, IA (US)

(72) Inventor: Michael A. Stoecker, Eldridge, IA (US)

(21) Appl. No.: 15/416,414

(22) Filed: Jan. 26, 2017

(51) Int. Cl. B23K 9/12; B23K 9/32; G01V 3/10

(52) U.S. Cl. CPC B23K 9/124; G01V 3/10; B23K 9/32

(57) ABSTRACT

A sensor system detects the level of weld wire in a supply drum used in a manual, automated, or robotic welding operation. The system includes a pair of sensors on the exterior of the drum and which illuminate a light in one color to indicate a sufficient supply of weld wire and then a second color to indicate a low or depleted level of weld wire within the drum. The sensor system will start and stop the welding operation, depending upon the level of weld wire within the drum. The system can also send a notification to a remote operator as to the level of wire in the drum.

### FIELD OF THE INVENTION

This invention generally relates to the field of welding, including manual, automated, and robotic particularly the invention is directed to a sensor system for weld wire supply drums used with welding machines and/or at welding stations. The invention monitors the level of weld wire in the drum utilizing one or more sensors mounted to the exterior of the drum.

The system includes a light operatively connected to the sensor which illuminates to indicate the level of wire in the drum. For example, a green light indicates a sufficient supply of weld wire to proceed with the welding operation, and a red light indicates a low or depleted supply of weld wire, which precludes the weld operation from proceeding. The system can also send a signal to a remote operator to notify the operator of a low or depleted supply of weld wire.

### BACKGROUND OF THE INVENTION

Manual, automated, and robotic welding is well known for many applications and in many industries. A conventional weld station typically includes a drum or container for holding the weld wire to be used in the welding operation. In prior art welding stations, the drum must be periodically manually inspected to check the level of the weld wire. When the weld wire is depleted, the operation must be stopped until a new supply of weld wire is provided in the drum. Such down time interrupts and slows productively, which is undesirable. If an automated or robotic machine continues without wire, the weld will not be complete, and the process will have to be reset after wire is added to the drum. Such operation can lead to incomplete weld beads or overlapping beads, neither of which is desirable.

Therefore, there is a need in the industry for a means and method of notifying an operator or personnel when the weld wire supply in the drum becomes low or depleted.

Accordingly, a primary objective of the present invention is the provision of a sensor system for a weld wire supply drum which automatically provides a visual indication of the level of weld wire in the drum.

Another objective of the present invention is the provision of a sensor system which can be retrofit to an existing weld wire supply drum.

Another objective of the present invention is the provision of a weld wire supply drum sensor system which automatically notifies an operator of the level of the weld wire in the supply drum.

Still another objective of the present invention is a provision of a sensor system for a weld wire supply drum which eliminates the need to manually check the level of weld wire in the drum.

A further objective of the present invention is the provision of a weld wire sensor system which can notify a remote operation when the weld wire level becomes low.

Still another objective of the present invention is the provision of a sensor system which can be retrofit to an existing weld wire supply drum to sense the wire level in the drum.

Yet another objective of the present invention is the provision of a weld wire sensor systems which automatically stops the welding machine when the weld wire reaches a pre-determined level in the supply drum.

Another objective of the present invention is the provision of a weld wire sensor system which is easy to install, and simple and accurate in use.

These and other objectives have become apparent from the following description of the invention.

### BRIEF DESCRIPTION OF THE DRAWINGS AND PHOTOGRAPHS

FIG. 1 is a side elevation schematic showing the sensor system of the present invention mounted to a weld wire supply drum, and indicating a sufficient level of weld wire within the drum.

FIG. 2 is a view similar to FIG. 1, but showing a low level of weld wire in the drum.

FIG. 3 is another view similar to FIG. 1, but showing a depleted level of weld wire within the drum.

FIG. 4 is a side elevation view of the sensor system for the weld wire supply drum, according to the present invention.

FIG. 5 is a perspective view showing the sensor housing mounted to a weld wire supply drum, with the indicator light removed from the housing.

FIG. 6 is a perspective view showing one embodiment of the sensor system according to the present invention.

FIG. 7 shows one style of a conventional weld wire supply drum.

FIG. 8 shows the interior of the drum of FIG. 7, with the top removed, and having a spool of weld wire inside the drum.

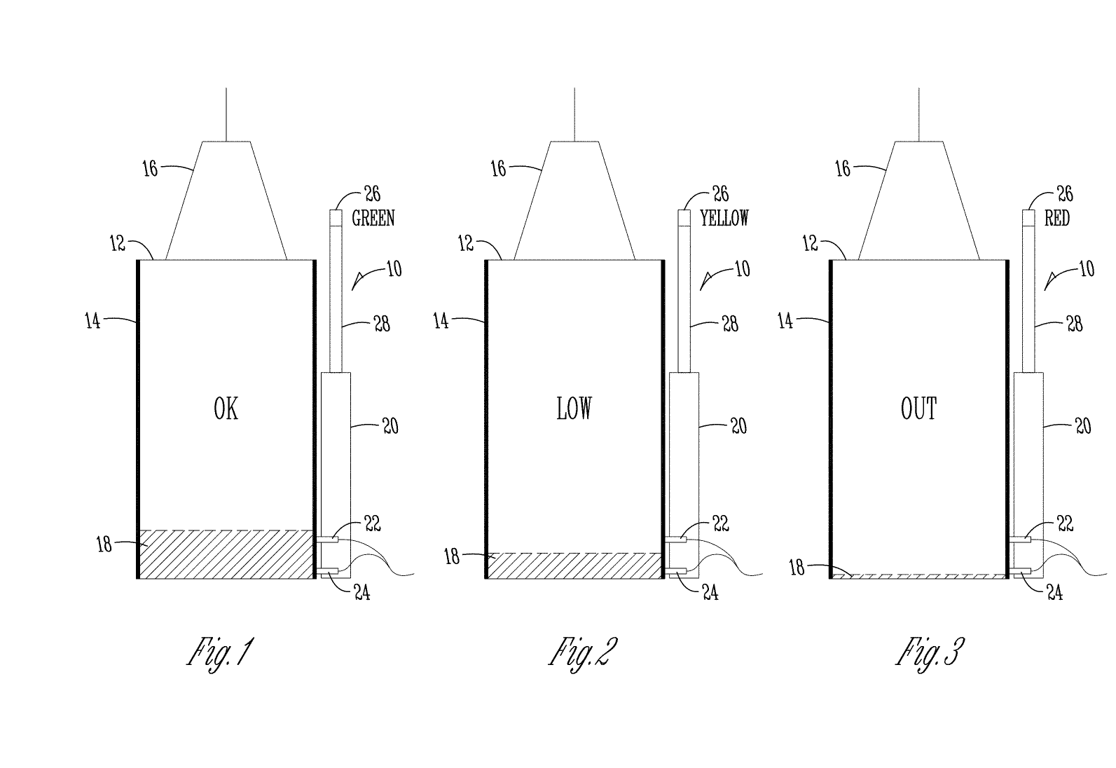

### DETAILED DESCRIPTION OF THE DRAWINGS AND PHOTOGRAPHS

The sensor system of the present invention is generally designated by the reference numeral 10 in the drawings, and is configured or adapted for use with manual, automated, and robotic welding operations. The sensor system 10 is mounted on a weld wire supply drum 12 of a welding machine or station. Typically, the side wall of the drum 12 is made of cardboard. The drum 12 has a removable cover or lid 16 to allow weld wire 18 to be loaded into the drum 12.

The sensor system 10 includes a housing 20 which is mounted to the drum side wall 14 in any convenient manner, such as strafes, adhesive, or fasteners. The housing 10 has an upper sensor 22 and a lower sensor 24. In the preferred embodiment, the sensors 22, 24 are inductive proximity sensors. One example of the sensors 22, 24 is Model No. IME30-38NPSZC0S sold by SICK, Inc.

Sensors 22, 24 are electrically coupled to a light 26 on the top of a post 28 extending upwardly from the housing 20. Preferably, the light 26 is a color-changing LED.

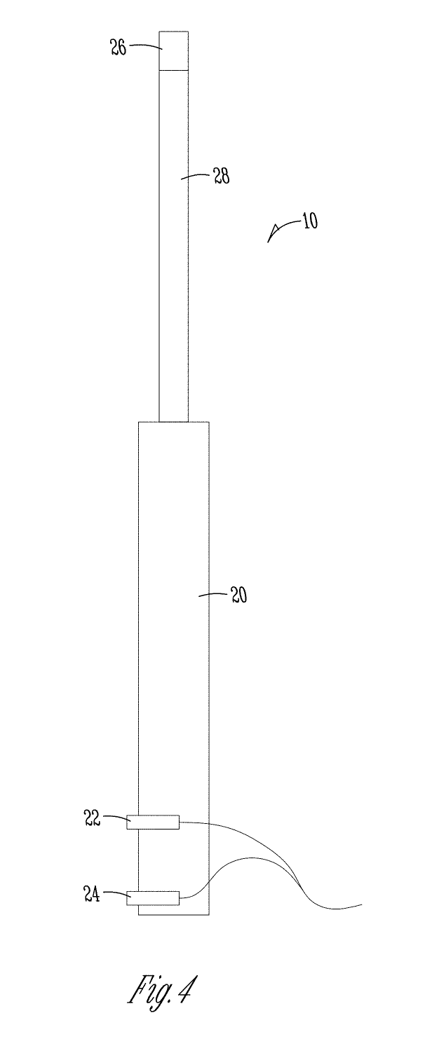

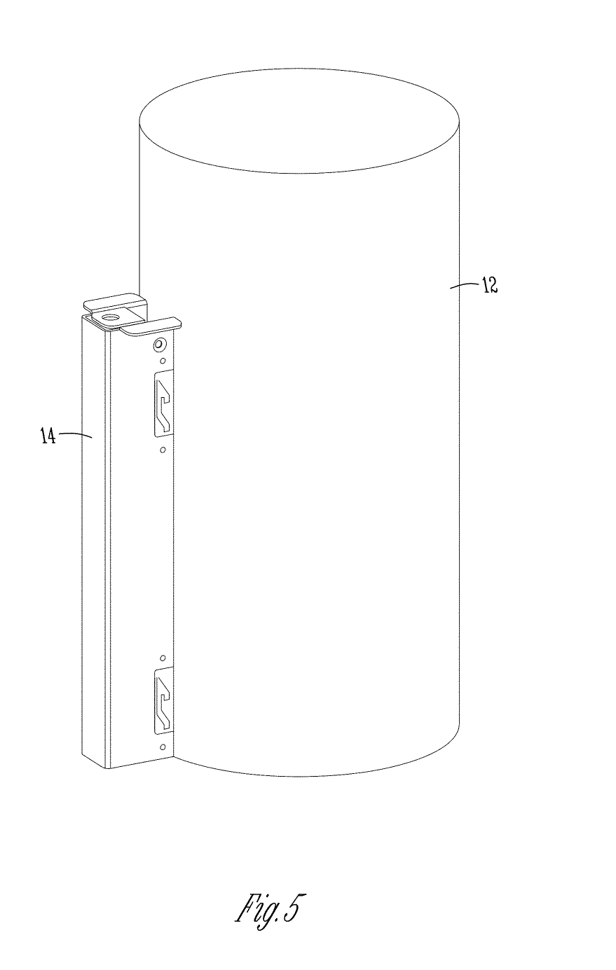

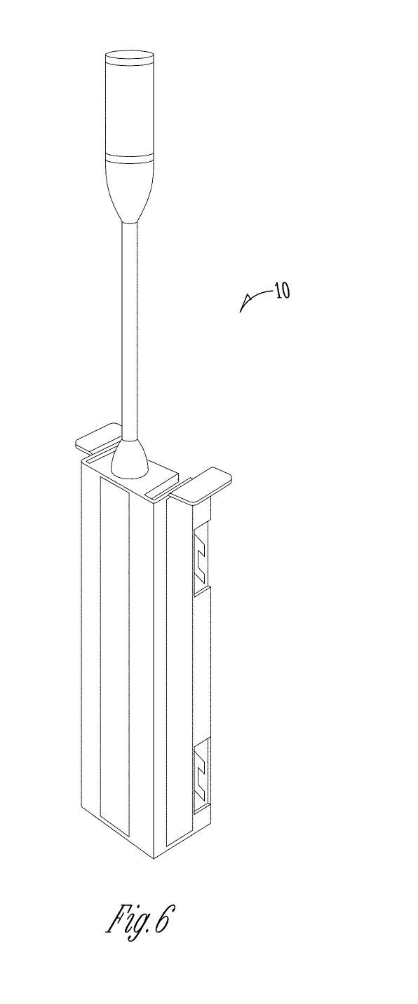

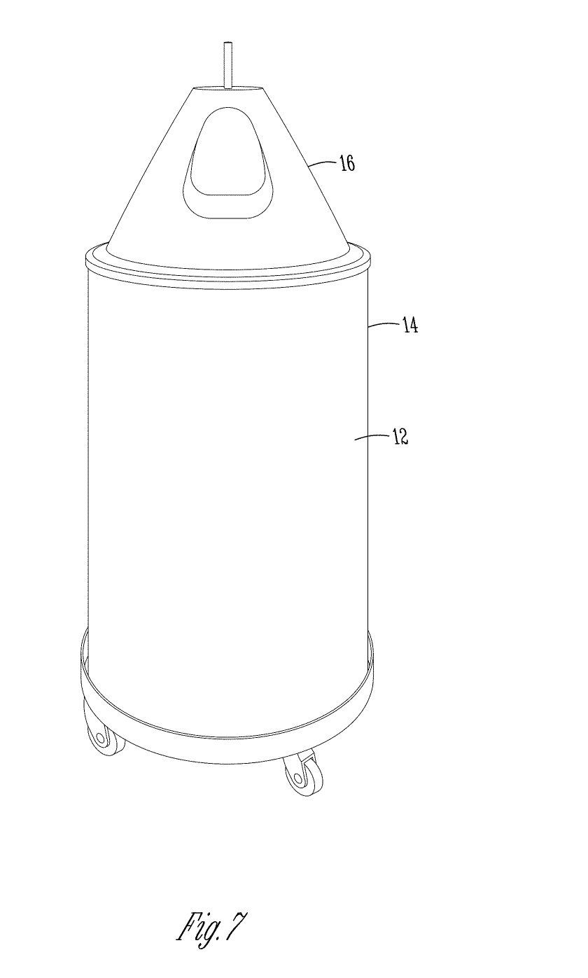

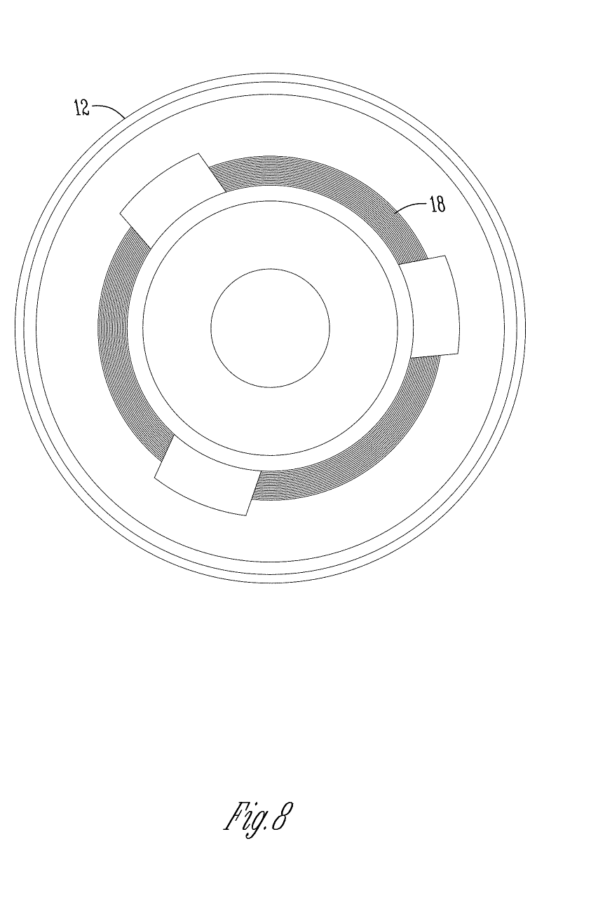

In operation, the sensor system 10 provides a visual indication of the level of weld wire 18 in the drum 12. For example, when there is a sufficient supply of wire 18 in the drum 12 to perform the welding operations, both sensors 22, 24 detect the presence of the wire in the drum, and send a signal to the light 26, which may be illuminated green, indicating that it is okay to proceed or continue the welding operation. As the welding operation uses the weld wire, the level of wire 18 in the drum 12 drops below the upper sensor 22, as shown in FIG. 2, which generates a different signal for the light 26, which changes to a different color, such as yellow, indicating a low level of wire in the drum. If the wire 18 is depleted to a level below the lower sensor 24, as shown in FIG. 3, a third signal is sent to the light 26, which again changes color, such as red, indicating an insufficient supply of weld wire to continue the welding operation.

As an alternative or in addition to the light 26, the sensor system 10 may include an audible indicia. For example, an alarm or other sound can be emitted from a speaker to indicate a low or exhausted supply of weld wire.

The sensor system 10 provides multiple functions. First, the system 10 provides a visual indication of the wire level in the drum, with a color of the light indicating whether the level is good, low, or out. The sensor system 10 provides a quick and simple visual indicia to an operator as to the level or status of weld wire 18 in the drum 12. When the level becomes low or exhausted, the operator can change the empty drum out with a new full drum, thereby minimizing down time for the welding operation and maximizing proactivity.

Secondly, the sensor system 10 can be connected to the controls of the automated/robotic welding machine so as to automatically stop the machine or prevent start of the operation when the weld wire level in the drum is low or out, as sensed by the sensors 22, 24. This function prevents the welding operation from proceeding if there is insufficient weld wire to complete the operation.

Thirdly, the system 10 can be connected to the welding machine controls and monitoring software to send notifications to personnel in a remote location or who otherwise cannot see the color of the light 26, and thereby allow someone to reload the drum with additional wire before the wire is completely depleted.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A sensor system for a weld wire supply drum having a cardboard sidewall, comprising:
a sensor mounted on an exterior surface of the drum to detect the level of weld wire in the drum.

2. The sensor system of claim 1 further comprising a visual indicator operatively connected to the light and being actuated and deactuated by the sensor.

3. The sensor system of claim 1 wherein the visual indicator is a light.

4. The sensor system of claim 3 wherein the light changes color in response to changing levels of weld wire in the drum.

5. The sensor system of claim 1 wherein the sensor is an inductive proximity sensor.

6. The sensor system of claim 1 wherein the sensor includes spaced apart upper and lower detectors to generate multiple signals corresponding to the level of weld wire in the drum.

7. The sensor system of claim 1 wherein the sensor generates a first signal corresponding to a first level of weld wire in the drum and a second signal corresponding to a second level of weld wire in the drum.

8. The sensor system of claim 1 wherein the sensor is operatively connected to a controller of an automated weld machine.

9. The sensor system of claim 8 wherein the sensor transmits signals to the controller corresponding to the level of weld wire in the drum.

10. The sensor system of claim 1 wherein the sensor sends signals to an operator for notifications of the weld wire level in the drum.

11. A method of controlling a welding operation at a welding station having a supply drum for holding weld wire, comprising:
mounting a sensor system to the exterior of the drum;
detecting the level of weld wire in the drum with at least one sensor of the sensor system; and
generating a signal corresponding to the level of weld wire in the drum.

12. The method of claim 1 wherein the signal is transmitted to a visual indicator of the weld wire level in the drum.

13. The method of claim 12 wherein the visual indicator is a light.

14. The method of claim 13 wherein the light changes color as the level of weld wire changes.

15. The method of claim 11 wherein the signal is transmitted to a controller on the machine to start and stop the operation in accordance with the level of weld wire in the drum.

16. The method of claim 11 wherein the signal is transmitted to a controller on the machine to stop the operation when the weld wire reaches a pre-determined level in the drum.

17. The method of claim 11 wherein the signal is transmitted to a remote operator to notify the operator of the weld wire level in the drum.

18. The method of claim 11 wherein the sensor generates multiple signals corresponding to different levels of weld wire in the drum.

19. The method of claim 11 wherein the sensor generates an audible signal corresponding to a low level of weld wire in the drum.

20. The method of claim 11 wherein the signal controls starting and stopping of the operation.
